(19) United States
(12) Patent Application Publication
(10) Pub. No.: US 2025/0236055 A1
(43) Pub. Date: Jul. 24, 2025

(54) GOLF BALL MOLD HAVING DIRECT VENTING

(71) Applicant: Acushnet Company, Fairhaven, MA (US)

(72) Inventors: Ajay Vora, Foxboro, MA (US); John M. Thornton, New Bedford, MA (US)

(73) Assignee: Acushnet Company, Fairhaven, MA (US)

(21) Appl. No.: 18/418,793

(22) Filed: Jan. 22, 2024

(51) Int. Cl. B29C 45/14; B29C 33/10

(52) U.S. Cl. CPC B29C 45/14819; B29C 33/10

(57) ABSTRACT

A golf ball mold assembly for quickly and efficiently eliminating air from within a mold includes a mold defining an interior spherical cavity for holding a golf ball subassembly. The mold assembly has a venting assembly having a plurality of pins extending parallel to an axis, the plurality of pins comprising a stationary center vent pin, a plurality of stationary flow-through pins, and a plurality of retractable pins. The mold assembly also has a vacuum bushing having a plurality of vent holes that extend parallel to the axis and lead to a collection area. A plurality of vent paths are formed from the interior spherical cavity to the collection area of the vacuum bushing, including at least one center vent path and at least one surrounding vent path.

### FIELD OF THE INVENTION

The present disclosure relates to golf ball molds and methods of molding golf balls, and, more particularly, to golf ball molds having components that enable direct venting during a molding process.

### BACKGROUND OF THE INVENTION

Both professional and amateur golfers alike generally use multi-piece, solid golf balls today. Typically, an outermost cover layer surrounds a golf ball subassembly which may be comprised of any number and combination of layers such as an inner core, outer core layer(s), intermediate layer(s), and/or inner cover layer(s).

An example of a common two-piece golf ball construction is a solid inner core, protected and surrounded by a cover. Three-piece, four-piece, and even five-piece balls have become more popular over the years, due to new manufacturing technologies, lower material costs, and desirable ball playing performance properties. In this regard the core itself can be multi-layered—for example, in a “dual-core” construction, the inner core can be made of a relatively soft and resilient material, while the surrounding outer core layer is made of a harder and more rigid material.

Different molding operations can be used to form the cover over the core or sub-assembly of the ball. For example, compression-molding, casting, and injection-molding processes can be used. These molding processes normally use molds having an upper mold cavity and lower mold cavity. Each mold cavity is hemispherical-shaped and one-half of the size of a finished ball. The mold cavities have interior walls with details defining the dimple pattern of the cover that will be produced. The upper and lower mold cavities are joined together under sufficient heat and pressure. The polyurethane material in the cavities encapsulates the ball subassembly and forms the cover of the ball.

Injection molding is a conventional method for forming thermoplastic polyurethane covers. Injection molding generally utilizes a mold and an injection unit. The lower mold cavity fits into a lower mold plate (frame) and defines a hemispherical molding cavity for receiving the core or ball sub-assembly. The plate defines a runner system for transporting the molten, polyurethane cover material to one or more gates that allow the material to enter the cavity from the runner system.

In one example of an injection-molding process, each mold cavity may also include retractable positioning pins to hold the core in the spherical center of the mold. Once the core is positioned in the first mold cavity, the respective second mold cavity is mated to the first to close the mold. A cover material is then injected into the closed mold. The positioning pins are retracted while the cover material is still flowable in order to allow the material to fill in any holes caused by the pins once the retractable pins are withdrawn. Thus, once the material being molded is at least partially cured, the covered core is removed from the mold. Different molds and molding systems have been used in the past to form golf ball covers, and these systems have been general effective. For example, Puniello et al., U.S. Pat. Nos. 7,223,085; 7,135,138; 6,877,974; and 6,235,230 describe different molding systems.

One drawback with using conventional molds and molding systems is that it can be difficult to ventilate fast enough the large volume of air that can be produced/present/trapped within the mold. For example, molding thin cover TPU (thermoplastic polyurethane) golf balls and other thin multi-layer golf ball constructions require ultra-fast cavity filling (˜200 to 400 ms) during injection molding in order to prevent flow front freezing before the entire cover geometry is formed and packed. This faster fill, combined with the very steep viscosity vs. shear rate characteristics of TPU in a thin dimpled cover molding, makes cavity/mold balancing and concentric flow front very difficult.

In fact, cavity/mold balancing and flow front variation can be significant even with slight changes in melt temperature and/or regrind and/or fill profile. Additionally, the location of cavities and runner systems introduces variation in shear—which, in turn, causes flow imbalances. These conditions can result in the production of tiny unfills, flow marks, and/or other defects because gases are not released fast enough or the vent path is not located at the point of gas trap. Furthermore, insufficient venting can result in undesirably reducing mold longevity from material becoming trapped in the mold.

Accordingly, there remains a need for new, cost-effective, efficient molds and molding methods wherein air and other gasses collecting within the mold at points of gas trap during molding can be exhausted/eliminated/removed quickly in order to eliminate molding defects, improve centering of the subassembly, and increase mold longevity without meanwhile negatively impacting desired golf ball durability physical properties, and performance characteristics. The molds and molding methods of the present disclosure address these and other needs and are particularly suited for ventilating air and other gasses while molding covers about golf ball subassemblies.

### SUMMARY OF THE INVENTION

According to an aspect of the present disclosure, a golf ball mold assembly is disclosed. The golf ball mold assembly includes a mold and a venting assembly. The mold includes a mold body and an arcuate inner surface including an inverted dimple and fret pattern. The mold defines an interior spherical cavity for holding a golf ball subassembly. The mold includes a plurality of through holes including a center through hole and a plurality of surrounding through holes. The venting assembly includes a plurality of pins extending parallel to an axis. The plurality of pins include a stationary center vent pin positioned in the center through hole, a plurality of stationary flow-through pins, and a plurality of retractable pins. The center vent pin and the plurality of stationary flow-through pins each include a vent portion extending along a length thereof. The plurality of stationary flow-through pins and the plurality of retractable pins are positioned in the plurality of surrounding through holes. The venting assembly also includes a vacuum bushing including a cavity-side surface, a collection area, and a plurality of vent holes each having an opening in the cavity-side surface and leading to the collection area through the vacuum bushing. The plurality of vent holes extend parallel to the axis and include a center vent hole and a plurality of surrounding vent holes. A plurality of vent paths are formed from the interior spherical cavity to the collection area of the vacuum bushing, including at least one center vent path through the center through hole and the center vent hole and at least one surrounding vent path through a surrounding through hole and a surrounding vent hole.

According to another aspect of the present disclosure, a vacuum bushing for a golf ball mold assembly is disclosed. The vacuum bushing includes a cavity-side surface, a distal end, and a collection area between the cavity-side surface and the distal end in a direction parallel to an axis. The vacuum bushing also includes a plurality of retractable pin through holes extending from the cavity-side surface to the distal end. The vacuum bushing further includes a plurality of vent holes each having an opening in the cavity-side surface and leading to the collection area, the plurality of vent holes extending parallel to the axis and including a center vent hole and a plurality of surrounding vent holes. The vacuum bushing also includes an exit channel connecting the center vent hole to the collection area.

According to another aspect of the present disclosure, a golf ball mold assembly is disclosed. The golf ball mold assembly includes a mold and a venting assembly. The mold includes a mold body and an arcuate inner surface including an inverted dimple and fret pattern. The mold defines an interior spherical cavity for holding a golf ball subassembly. The mold includes a plurality of through holes including a center through hole and a plurality of surrounding through holes. The venting assembly includes a plurality of pins extending parallel to an axis, the plurality of pins including a stationary center vent pin positioned in the center through hole and a plurality of retractable pins positioned in the plurality of surrounding through holes. The center vent pin includes a vent portion extending along a length thereof. The venting assembly also includes a vacuum bushing including a cavity-side surface, a collection area, and a center vent hole having an opening in the cavity-side surface and leading to the collection area, wherein the center vent hole extends parallel to the axis. The opening of the center vent hole includes a covered portion that is covered by the center vent pin and an uncovered portion that is not covered by the center vent pin. The uncovered portion forms part of a vent path from the interior spherical cavity to the collection side of the vacuum bushing. The covered portion of the opening of the center vent hole includes the center point of the opening

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a front view of a golf ball mold assembly, consistent with disclosed embodiments;

FIG. 2 is a front view of the golf ball mold assembly of FIG. 1 with an upper mold cavity hidden;

FIG. 3 is a cross-sectional view of the golf ball mold assembly of FIG. 2, taken along line A-A;

FIG. 4 is a top perspective view of a mold cavity, consistent with disclosed embodiments;

FIG. 5 is a bottom view of the mold cavity of FIG. 4;

FIG. 6 is a top perspective view of the mold cavity of FIG. 4 together with a venting assembly, consistent with disclosed embodiments;

FIG. 7 is a top perspective view of the venting assembly of FIG. 6 with the mold cavity hidden;

FIG. 8 is an exploded view of the venting assembly of FIG. 7;

FIG. 9 is a top perspective view of a vacuum bushing, consistent with disclosed embodiments;

FIG. 10 is a top view of the vacuum bushing of FIG. 9;

FIG. 11 is a front view of the vacuum bushing of FIG. 9;

FIG. 12 is a close-up view a circled portion of FIG. 11 further illustrating an exit channel of the vacuum bushing, consistent with disclosed embodiments;

FIG. 13 is a cross-sectional view of the vacuum bushing of FIG. 9, taken along line B-B of FIG. 10;

FIG. 14 is a cross-sectional view of the vacuum bushing of FIG. 9, taken along line C-C of FIG. 10;

FIG. 15 is a cross-sectional view of the vacuum bushing of FIG. 9, taken along line D-D of FIG. 11;

FIG. 16 is a front perspective view of a center vent pin, consistent with disclosed embodiments;

FIG. 17 is a front view of the center vent pin of FIG. 16;

FIG. 18 is a top view of the center vent pin of FIG. 16;

FIG. 19 is a cross-sectional view of the center vent pin of FIG. 16, taken along line E-E of FIG. 17;

FIG. 20 is a close-up view of a circled portion of FIG. 19 further illustrating an exit vent of the center vent pin, consistent with disclosed embodiments;

FIG. 21 is a front perspective view of a flow-through pin, consistent with disclosed embodiments;

FIG. 22 is a front view of the flow-through pin of FIG. 21;

FIG. 23 is a top view of the flow-through pin of FIG. 21;

FIG. 24 is a top view of some components of a golf ball mold assembly, including a center vent pin, surrounding flow-through pins, and a vacuum bushing, consistent with disclosed embodiments;

FIG. 25 is a cross-sectional view of the golf ball mold assembly components of FIG. 24, taken along line F-F of FIG. 24;

FIG. 26 is a close-up view of the center vent pin partially covering a center vent hole of the vacuum bushing of FIG. 24; and

FIG. 27 is a close-up view of a surrounding flow-through pin partially covering a surrounding vent hole of the vacuum bushing of FIG. 24.

### DETAILED DESCRIPTION OF THE INVENTION

The present disclosure generally relates to golf ball mold assemblies and methods for molding golf balls, particularly golf balls having thermoplastic polyurethane covers. Advantageously, the disclosed embodiments include improved venting components and features to enable air to be quickly and efficiently vented from within a mold. Where the present disclosure refers to the venting of air it should be understood that the term air is inclusive of other gasses that may be within a mold and vented via a disclosed system.

In one example, a disclosed golf ball mold assembly includes a stationary center vent pin having features for direct venting through a mold cavity and vacuum bushing to a collection area. The collection area may be connected to a vacuum plate for producing a suction force to draw air through the vents in the golf ball mold assembly. The vacuum bushing includes a plurality of vent holes, including a center vent hole associated with the center vent pin and surrounding vent holes associated with stationary flow-through pins that also enable direct venting. The venting assembly thereby provides quick and efficient venting during a molding cycle, allowing for consistent molding of thin covers without issues and defects.

Conventionally, golf ball covers are made by either compression molding two preformed half shells about a core or by injection molding of a thermoplastic material about a core. The present disclosure relates to a retractable pin injection molding (“RPIM”) system and includes components configured to perform an RPIM cycle to mold a spherical layer of a golf ball. RPIM involves a pair of substantially hemispherical mold cavities that include gates, which allow heated, viscous thermoplastic polymeric injection material intended for the layer to pass into the mold, and vents, which allow trapped air and gases to escape from the mold. Retractable pins are positioned to hold the core or subassembly about which the layer is to be formed centered within the spherical mold cavity. The injection material is injected into the spherical cavity through the gates and trapped air and gases escape through the vents. When the mold is filled with injection material such that the golf ball subassembly has stabilized within the injection material, the retractable pins are retracted, and the injection material flows into and fills the space vacated by the retractable pins. After the mold is completely filled with injection material, the injection material is allowed to harden. The mold is then opened, and the molded golf ball is ejected, either via ejector pins, or by another method known in the art.

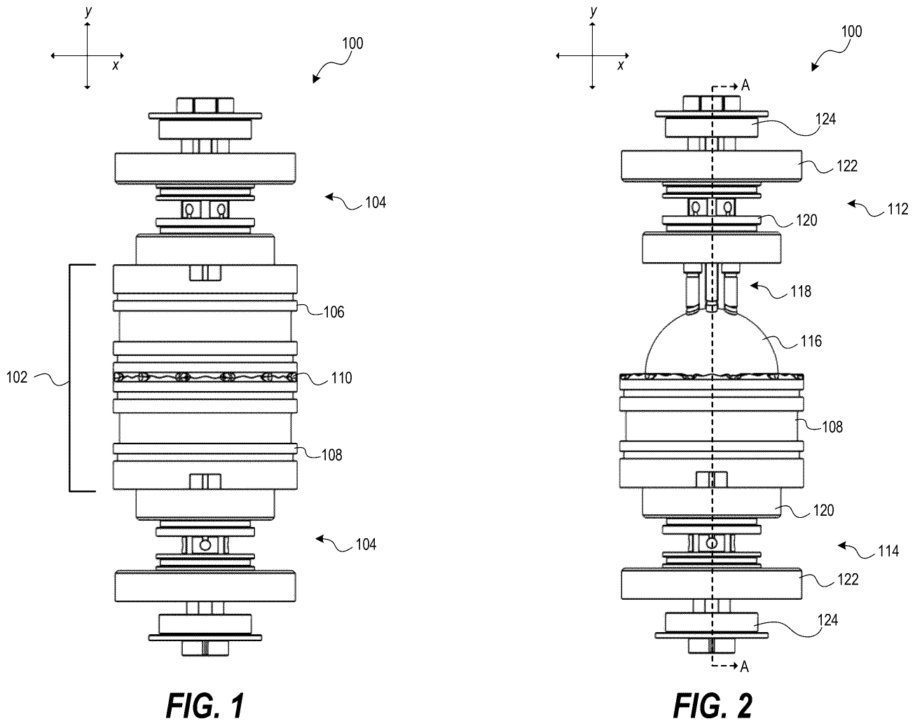

Referring to FIG. 1, a golf ball mold assembly 100 includes a mold 102 and a venting assembly 104. In an exemplary embodiment, the golf ball mold assembly 100 is part of an RPIM system configured to perform at least an injection molding step of a golf ball manufacturing process. An RPIM system may include the golf ball mold assembly 100 in addition to other components, such as one or more plates configured to hold the mold 102 in a position for molding a golf ball layer, an injection runner system, a cooling system, and other venting components such as a vacuum source and vacuum plate. In one example, an RPIM system may include a platen structure configured to receive a plurality of mold assemblies 100 for simultaneously molding a plurality of golf ball layers around a plurality of golf ball subassemblies.

The mold 102 defines an interior spherical cavity. In an exemplary embodiment, the mold 102 includes an upper mold cavity 106 and a lower mold cavity 108. The terms “upper” and “lower” do not necessarily imply a spatial configuration and are used to differentiate the similar components in the accompanying figures. In an exemplary embodiment, the upper mold cavity 106 and lower mold cavity 108 are two halves of the mold 102 and each form half or approximately half of a golf ball layer during a molding process. In an exemplary embodiment, the mold cavities 106, 108 are made from a metal material, for example, stainless steel, brass, or silicon bronze. These metals provide the mold cavities 106, 108 with high durability, mechanical strength, and efficient thermal transfer. The metal mold cavities can withstand higher pressures and temperatures without deforming. When the upper and lower mold cavities 106, 108 are joined together, they define an interior spherical cavity that forms the cover for the golf ball.

The upper mold cavity 106 and lower mold cavity 108 are stacked relative to each other along an axis, which in this example is the y-axis. A plurality of gates 110 are formed at a junction between the upper mold cavity 106 and the lower mold cavity 108. The plurality of gates 110 form openings for directing injection material into the interior spherical cavity of the mold 102 to form a layer, such as a cover layer.

The venting assembly 104 includes an upper assembly 112 and a lower assembly 114. The upper assembly 112 and lower assembly 114 may include identical components respectively associated with the upper mold cavity 106 and the lower mold cavity 108. The upper assembly 112 is distal to the upper mold cavity 106 along the y-axis and the lower assembly 114 is distal to the lower mold cavity 108 along the y-axis such that the venting assembly 104 is positioned at opposite ends of the mold assembly 100.

FIG. 2 is the same view of the mold assembly 100 as FIG. 1, with the upper mold cavity 106 removed, thereby depicting a golf ball subassembly 116 within the interior spherical cavity of the mold 102. The mold assembly 100 is configured to mold a cover layer around the golf ball subassembly 116. For example, injection material in the mold cavities 106, 108 adheres to the golf ball subassembly to form a unitary and integral cover structure. In an exemplary embodiment, the golf ball subassembly 116 refers to a core structure and any intermediate layers disposed about the core such as casing, mantle, or intermediate layers.

FIG. 2 further depicts exemplary components of the venting assembly 104. The venting assembly 104 includes a plurality pins 118, a vacuum bushing 120, a vacuum cap 122, and a cluster block 124. The vacuum cap 122 may be a separate or integral component that seals a portion of the vacuum bushing enabling a vacuum plate to be attached and draw air through the vacuum bushing 120 from the interior spherical cavity of the mold 102 via a vacuum source. In an exemplary embodiment, upper assembly 112 and the lower assembly 114 each include these features respectively associated with the upper mold cavity 106 and the lower mold cavity 108.

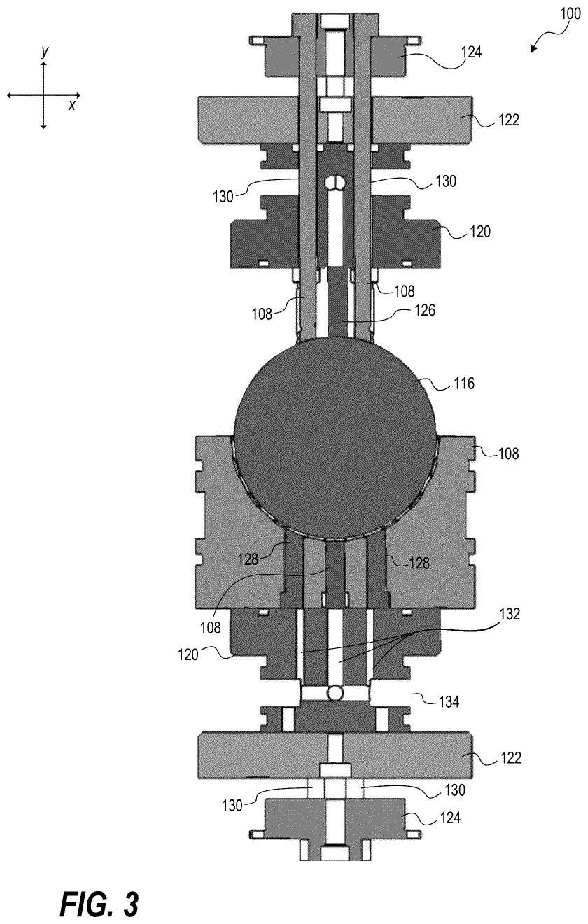

FIG. 3 is a cross-sectional view of the mold assembly 100, taken along line A-A of FIG. 2. FIG. 3 further depicts an interior of the mold 102 and the vacuum bushing 120. In an exemplary embodiment, the upper mold cavity 106 and upper assembly 112 are rotationally offset relative to the lower mold cavity 108 and lower assembly, and thus different cross sections are seen at the opposing sides of the mold assembly 100.

In an exemplary embodiment, the plurality of pins 118 include a center vent pin 126, flow-through pins 128, and retractable pins 130. The vacuum bushing 120 includes a plurality of vent holes 132 and a collection area 134 for enabling flow of air out of the interior spherical cavity. The center vent pin 126 and the flow-through pins 128 are stationary pins that are positioned in the mold 102 and remain separate from the vacuum bushing 120. The retractable pins 130 extend through the mold 102 and the vacuum bushing 120 and are connected to each other by the cluster block 124. For each of the upper assembly 112 and lower assembly 114, movement of the cluster block 124 in a direction parallel to the y-axis moves the retractable pins 130 relative to the mold 102 and the vacuum bushing 120 (e.g., to move the retractable pins 130 out of the interior spherical cavity of the mold 102 during molding).

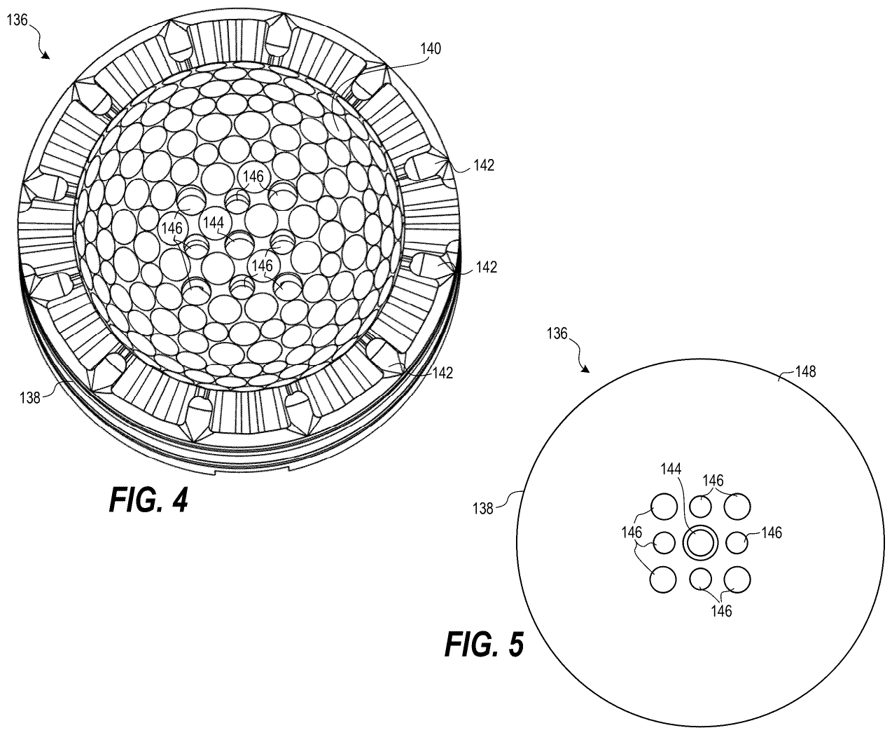

FIG. 4 is a perspective view of a mold cavity 136. The mold cavity 136 is a component of a mold, such as the mold 102, and is representative of at least one of the upper mold cavity 106 and the lower mold cavity 108. The mold cavity 136 includes a mold body 138 that defines an arcuate inner surface 140 configured to form an injection material into a solid golf ball layer. The inner surface 140 defines an interior hemispherical cavity that becomes an interior spherical cavity when two mold cavities are put together. In an exemplary embodiment, the inner surface 140 includes an inverted dimple and fret pattern corresponding to a dimple pattern for a golf ball. Various geometrical dimple patterns may be used in accordance with the disclosed embodiments.

The mold cavity 136 also includes a plurality of gates 142 for allowing injection material to be delivered into the interior spherical cavity. The mold cavity 136 is thus configured to receive a golf ball subassembly (e.g., a golf ball core) and also receive an injection material between the golf ball subassembly and the inner surface 140. The injection material thereafter hardens into a layer that surrounds and encloses the golf ball subassembly and includes a surface texture and pattern corresponding to the inner surface 140, such as a dimple pattern corresponding to the inverted dimple and fret pattern of the inner surface 140. In another example, the molded layer may have be a smooth outer surface of a casing layer.

The mold cavity 136 includes a plurality of through holes formed in the mold body 138, including a center through hole 144 and a plurality of surrounding through holes 146. In the embodiment of FIG. 4, the mold cavity 136 includes eight surrounding through holes 146 spaced around the center through hole 144. As is known in the art, the through holes 144, 146 may be placed at locations on the inner surface 140 corresponding to dimples of an inverted dimple and fret pattern. The through holes 144, 146 extend from the interior spherical cavity through the mold body 138 to a distal surface 148 shown in FIG. 5. The through holes 144, 146 may be formed as cylindrical channels, and when the mold cavity 136 is positioned in a mold assembly like the mold assembly 100, the through holes 144, 146 extend parallel to the y-axis. The through holes 144, 146 may have different diameters or be the same. In the embodiment of FIGS. 4 and 5, the center through hole 144 is a different size than the surrounding through holes 146. Within the surrounding through holes 146, the four “corner” through holes have larger diameters than the four “middle” through holes.

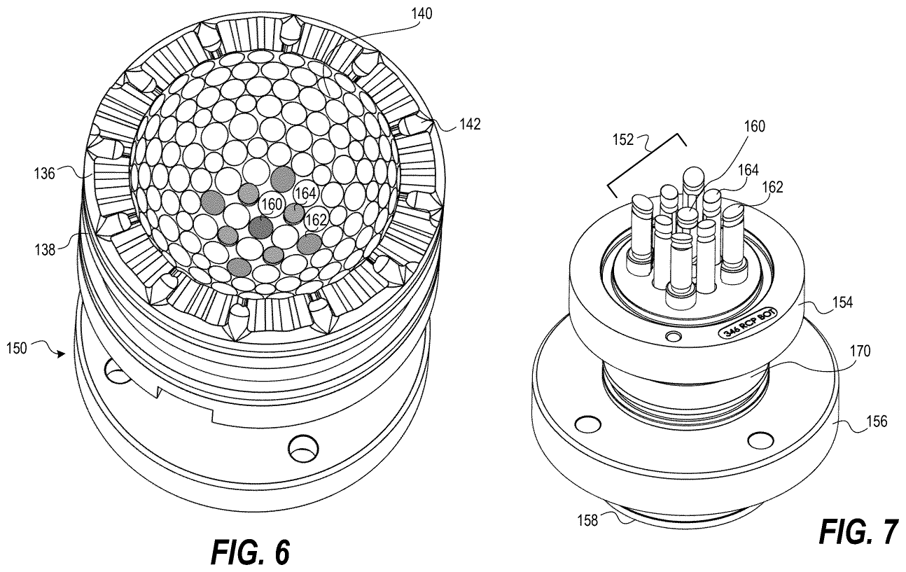

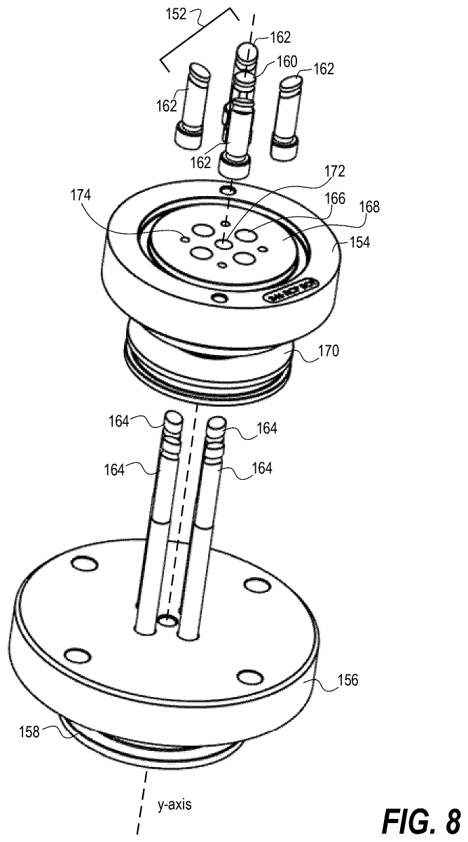

FIG. 6 is a top perspective view of the mold cavity 136 in combination with a venting assembly 150. The venting assembly 150 is a component of a mold, such as the mold 102, and is representative of at least one of the upper assembly 112 and the lower assembly 114. FIG. 7 is a perspective view of the venting assembly 150 without the mold cavity 136. FIG. 8 is an exploded view of the venting assembly 150. The venting assembly 150 includes a plurality of pins 152, a vacuum bushing 154, a vacuum cap 156, and a cluster block 158. In some embodiments of the mold assembly 100, the plurality of pins 152 may be used as the plurality of pins 118, the vacuum bushing 154 may be used as the vacuum bushings 120, the vacuum cap 156 may be used as the vacuum caps 122, and the cluster block 158 may be used as the cluster blocks 124. The plurality of pins 152 includes a stationary center vent pin 160, a plurality of stationary flow-through pins 162, and a plurality of retractable pins 164.

The plurality of pins 152 at least partially seat within the through holes 144, 146 of the mold cavity 136. In an exemplary embodiment, the center vent pin 160 is positioned in the center through hole 144 and the flow-through pins 162 and the plurality of retractable pins 164 are positioned in the surrounding through holes 146. The flow-through pins 162 may be positioned in the “corner” through holes and the retractable pins 164 may be positioned in the “middle” through holes. As shown in FIG. 6, the tops of the plurality of pins 152 complete the inner surface 140. In an exemplary embodiment, the plurality of pins 152 include inverted dimples to complete the inverted dimple and fret pattern of the inner surface 140. The plurality of pins 152 may include diameters that are slightly smaller than the through holes 144, 146 to enable air to escape the interior spherical cavity through the through-holes 144-146 while the plurality of pins 152 are in position.

Turning to FIGS. 7-8, the retractable pins 164 are connected at the cluster block 158 and extend through the vacuum cap 156 and the vacuum bushing 154 in a direction parallel to an axis, which in this example is the y-axis in FIG. 8. The vacuum bushing 154 includes a plurality of retractable pin through holes 166 for receiving the retractable pins 164 therethrough. The retractable pins 164 are activated by a mechanism (not shown) that controls movement of the retractable pins 164 to engage with a golf ball subassembly to hold it securely in place. The mechanism may be actuated in a variety of manners known within the art, such as hydraulically or pneumatically. The vacuum bushing 154 also includes a cavity-side surface 168 which extends on a plane perpendicular to the y-axis. The center vent pin 160 and flow-through pins 162 are positioned adjacent to the cavity-side surface 168. Further, with the mold cavity 136 in place with the plurality of pins 152, the distal surface 148 is positioned adjacent to the cavity-side surface 168. The vacuum bushing 154 further includes a collection area 170.

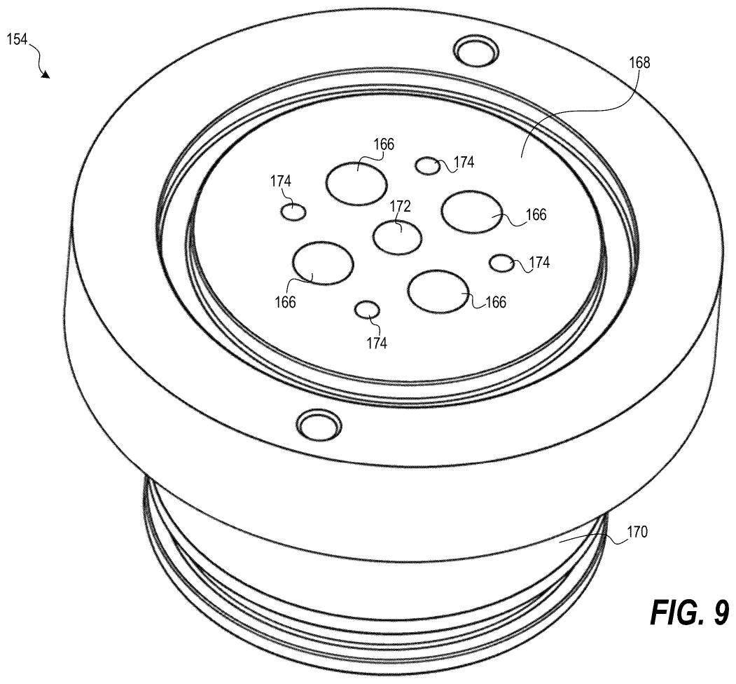

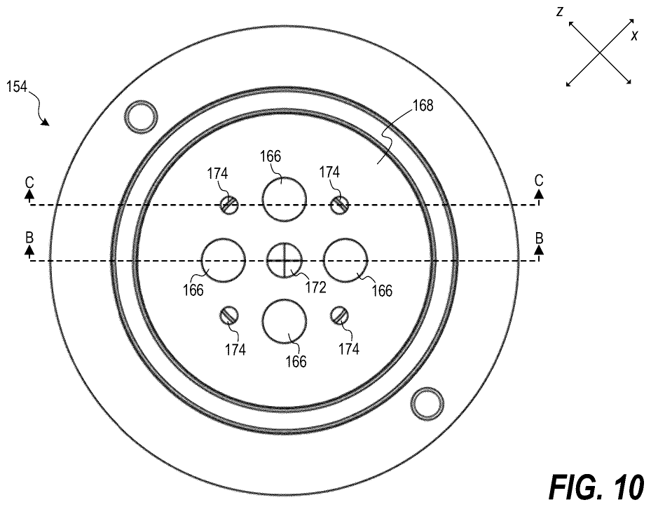

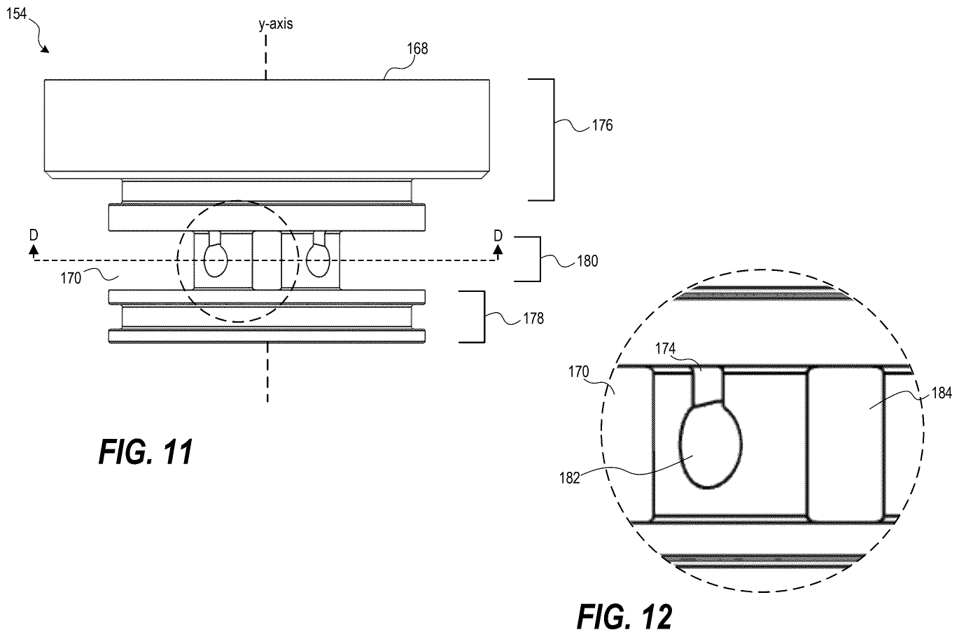

FIG. 9 is a top perspective view, FIG. 10 is a top view, and FIG. 11 is a front view of the vacuum bushing 154. The vacuum bushing 154 includes a plurality of vent holes each having an opening in the cavity-side surface 168 and leading to the collection area 170 through the vacuum bushing 154. The plurality of vent holes include a center vent hole 172 and a plurality of surrounding vent holes 174. In an exemplary embodiment, the vacuum bushing 154 includes four surrounding vent holes 174 positioned at “corners” equally spaced around the center vent hole 172. The center vent hole 172 and the surrounding vent holes 174 include circular openings at the cavity-side surface 168, but may have other shapes in other embodiments. The openings into the surrounding vent holes 174 may have a smaller diameter than the opening into the center vent hole 172. The vacuum bushing 154 includes four retractable pin through holes 166 equally spaced around the center vent hole 172. The openings into the retractable pin through holes 166 may have a larger diameter than the openings into the plurality of vent holes.

The vacuum bushing 154 includes a proximal end near the cavity-side surface 168 and a distal end on an opposing end from the cavity-side surface 168. The vacuum bushing 154 may include a support section 176 at the proximal end, a base section 178 at the distal end, and an outlet section 180 therebetween. The collection area 170 is between the cavity-side surface 168 and the distal end along a direction parallel to the y-axis. The collection area 170 may be formed as an annular recess defined by the outlet section 180 being smaller in diameter than the support section 176 and the base section 178. In an exemplary embodiment, the center vent hole 172 and the surrounding vent holes 174 connect the openings at the cavity-side surface 168 to the collection area 170. The vacuum bushing 154 may be connected to a vacuum source configured to produce a suction force to draw air through the mold cavity 136 and the vacuum bushing 154 to the collection area 170.

In an exemplary embodiment, the vacuum bushing 154 further includes an exit channel 182 connecting the center vent hole 172 to the collection area 170. The vacuum bushing 154 includes a plurality of exit channels 182. The exit channels 182 are formed in the outlet section 180 and extend perpendicular to the y-axis (e.g., in a direction parallel to an x-axis or a z-axis). The vacuum bushing 154 may further include a through hole vent 184 connecting one of the retractable pin through holes 166 to the collection area 170, thereby enabling venting through the retractable pin through holes 166. The vacuum bushing 154 includes a plurality of through hole vents 184, one for each of the retractable pin through holes 166. FIG. 12 is a close-up view of the outlet section 180 showing one of the exit channels 182 and one of the through hole vents 184. In an exemplary embodiment, one of the surrounding vent holes 174 intersects a portion of a respective exit channel 182.

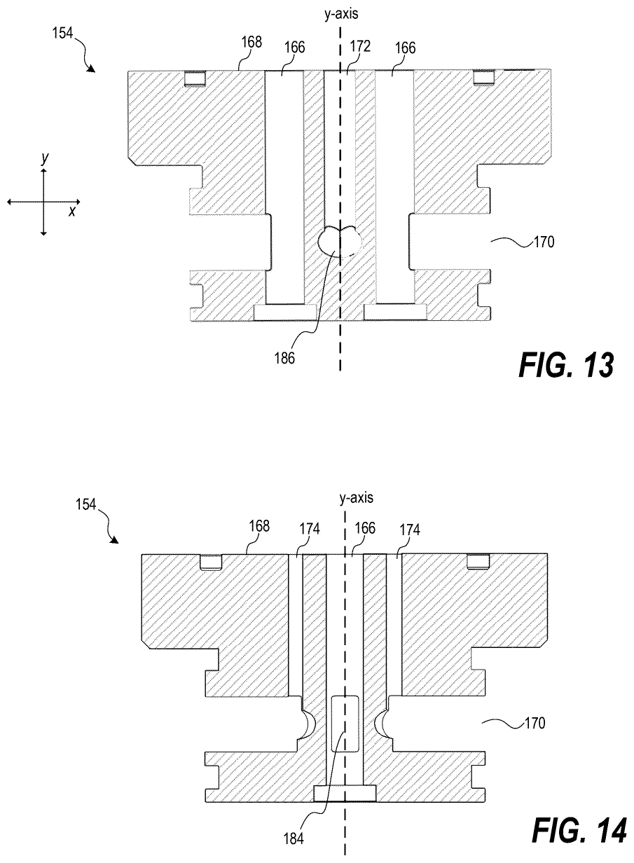

FIG. 13 is a cross-sectional view of the vacuum bushing 154, taken along line B-B of FIG. 10, going through the center vent hole 172 and two of the retractable pin through holes 166. FIG. 14 is a cross-sectional view of the vacuum bushing 154, taken along line C-C of FIG. 10, going through a retractable pin through hole 166 and two of the surrounding vent holes 174. The retractable pin through holes 166 extend parallel to the y-axis and are continuous through the vacuum bushing 154 to enable the retractable pins 164 to pass through. The retractable pin through holes 166 may include the through hole vents 184 to enable venting of through the retractable pin through holes 166 to the collection area 170. The center vent hole 172 extends parallel to the y-axis from the cavity-side surface 168 to an exit junction 186 which transitions into the exit channels 182. The surrounding vent holes 174 extend parallel to the y-axis from the cavity-side surface 168 to the collection area 170 and, in an exemplary embodiment, intersect a respective exit channel 182.

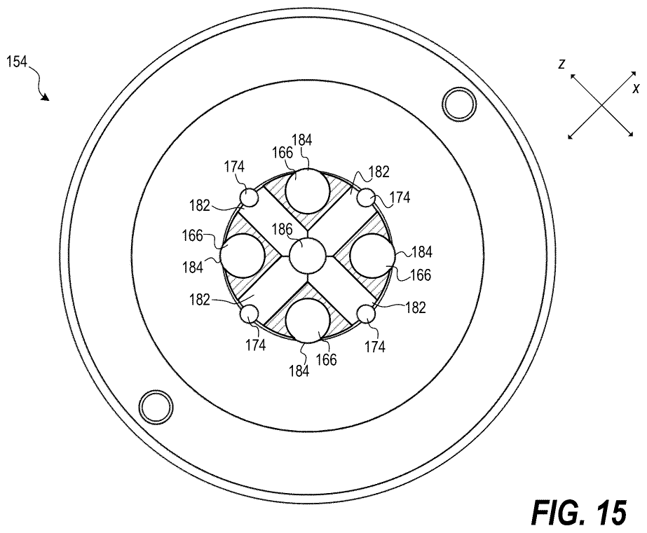

FIG. 15 is a cross-sectional view of the vacuum bushing 154, taken along line D-D of FIG. 11, going through the outlet section 180 at the exit junction 186. As shown, the exit junction 186 diverts into the exit channels 182, which extend in a direction perpendicular to the y-axis (e.g., in a direction parallel to the x-axis or z-axis). In an exemplary embodiment, the exit channels 182 form two dual-open-ended channels that extend perpendicular to each other. In an embodiment, the retractable pin through holes 166 pass between the exit channels 182 within the outlet section 180, with exposure to the collection area 170 at the through hole vents 184. In an embodiment, the surrounding vent holes 174 partially intersect the exit channels 182 and partially lead directly into the collection area 170.

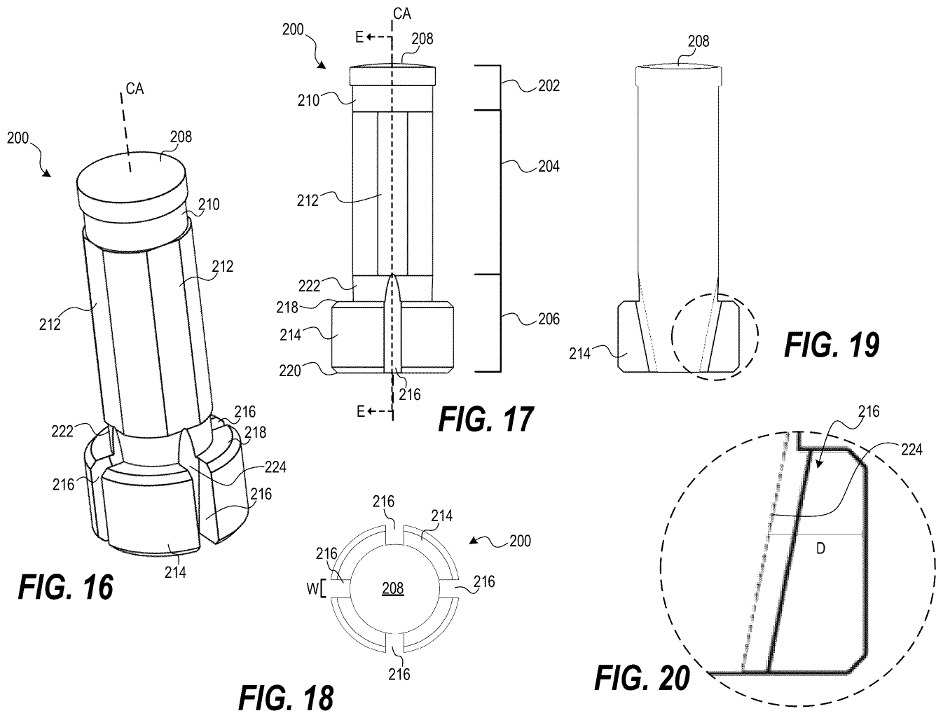

FIGS. 16-20 depict an embodiment of a center vent pin 200. In some of the disclosed embodiments, the center vent pin 200 is the same as the center vent pins 126, 160. For example, the center vent pin 200 may be used in conjunction with the mold assembly 100 to provide direct venting through the vacuum bushing 120. The center vent pin 200 extends longitudinally generally parallel to a center axis CA. The center vent pin 200 further includes a vent portion extending along a length of the center vent pin 200. The vent portion enables air to travel along the longitudinal length of the center vent pin 200 while the center vent pin 200 is positioned in the center through hole 144 of the mold cavity 136.

The center vent pin 200 includes, along the y-axis, a proximal section 202, a middle section 204, and a distal section 206. The proximal section 202 includes an upper surface 208. In an embodiment, the upper surface 208 is an inverted dimple shape and configuration. The upper surface 208 is configured to fit within and at least partially fill the opening into the center through hole 144 to complete a missing area of the inner surface 140. In an exemplary embodiment, the upper surface 208 is part of an inverted dimple and fret pattern on the inner surface 140. While the depicted embodiment includes a whole dimple, it should be understood that the upper surface 208 can have other shapes and configurations, such as a shape including part of a fret and/or part of a dimple in an inverted dimple and fret pattern.

The proximal section 202 further includes a proximal vent 210. The proximal vent 210 is in fluid communication with the interior spherical cavity of the mold 102 during molding. For example, the upper surface 208 may have a diameter smaller than the opening into the center through hole 144. In an exemplary embodiment, the proximal vent 210 is formed as an annular recess beneath the upper surface 208. For example, the proximal vent 210 may be an elliptical channel with a rounded wall. The proximal vent 210 is sized to quickly gather air from the interior spherical cavity of the mold cavity 136.

The middle section 204 is the longest longitudinal section of the center vent pin 200. The middle section 204 includes a surface vent 212. The surface vent 212 is in fluid communication with the proximal vent 210. In an exemplary embodiment, the surface vent 212 enables air to travel in a direction parallel to the y-axis along the center vent pin 200 through the center through hole 144. The middle section 204 includes a circular profile with the surface vent 212 being formed as a flattened portion of profile, thereby providing a gap between the surface of the middle section 204 and the wall forming the center through hole 144. In an exemplary embodiment, the middle section 204 includes a plurality of surface vents 212. In the depicted embodiment, the middle section 204 includes four surface vents 212 equally spaced around the perimeter of the middle section 204.

In an exemplary embodiment, the distal section 206 includes a support block 214 and an exit vent 216. The term “support block” is not limited to elements that provide support. The support block 214 may be an enlarged end of the center vent pin 200 relative to the proximal section 202 and the middle section 204. The mold cavity 136 may include an enlarged opening in the distal surface 148 that receives the support block 214. The support block 214 includes a first end 218 adjacent the middle section 204 and an opposite second end 220 along the y-axis. In some embodiments, the center vent pin 200 includes a distal vent 222 at the first end 218 of the support block 214. The distal vent 222 may be similar to the proximal vent 210 in being formed as an annular recess to collect air. The distal vent 222 is in fluid communication with the surface vents 212. The support block 214 is configured to be adjacent to the cavity-side surface 168 of the vacuum bushing 154. For example, the second end 220 may rest on the cavity-side surface 168.

The support block 214 defines a maximum diameter through the center axis of the center vent pin 200. As will be described in more detail, the maximum diameter of the support block 214 may be greater than the diameter of the opening of the center vent hole 172 of the vacuum bushing 154. In one example, the maximum diameter is about 0.20-0.23″. In an embodiment, the maximum diameter is 0.215″. The exit vent 216 is in fluid communication with the surface vent 212 (e.g., via the distal vent 222). In an exemplary embodiment, the exit vent 216 is formed as a recess from the maximum diameter of the support block 214 toward the center axis of the center vent pin 200. The exit vent 216 recess extends from the first end 218 to the second end 220 to form a complete path through the support block 214. In some embodiments, each exit vent 216 has a constant width W. The width may be about 0.3″ but embodiments are not limited thereto.

In an exemplary embodiment, the center vent pin 200 includes a plurality of exit vents 216. For example, in the depicted embodiment, the center vent pin 200 includes four exit vents 216. Each exit vent 216 may be aligned with a respective surface vent 212 such that a direct vent path is formed in a direction parallel to the y-axis for each surface vent/exit vent pairing.

As shown in FIG. 20, each exit vent 216 includes an exit surface 224 within the recess. The exit surface 224 defines a radially-innermost extent of the exit vent 216. The exit surface 224 extends from the first end 218 to the second end 220 of the support block 214. In some embodiments, the exit surface 224 may be rounded. In some embodiments, the exit surface 224 may extend into the distal vent 222. In an exemplary embodiment, the exit surface 224 is pitched toward the center axis of the center vent pin 200. As a result, the exit vent 216 has a depth D from the maximum diameter to the exit surface 224 that increases from the first end 218 to the second end 220. In an exemplary embodiment, the exit surface 224 is pitched about 7-15° relative to the y-axis. For example, the exit surface 224 may be pitched about 11° relative to the y-axis.

As described herein, the center vent pin 200 includes a vent portion extending along a length thereof. The vent portion may be some or all of the proximal vent 210, surface vents 212, exit vents 216, and/or distal vent 222. The vent portion provides direct venting that enables air to quickly and efficiently travel in a direction generally parallel to the y-axis through the center through hole 144 and exit through the exit vents 216 toward the vacuum bushing 154 during molding. While the proximal vent 210 and distal vent 222 are depicted and described as annular recesses, it should be understood that other configurations are possible. Further, while four equally-spaced surface vents 212 and exit vents 216 are shown, other numbers of pairings of these vents are possible.

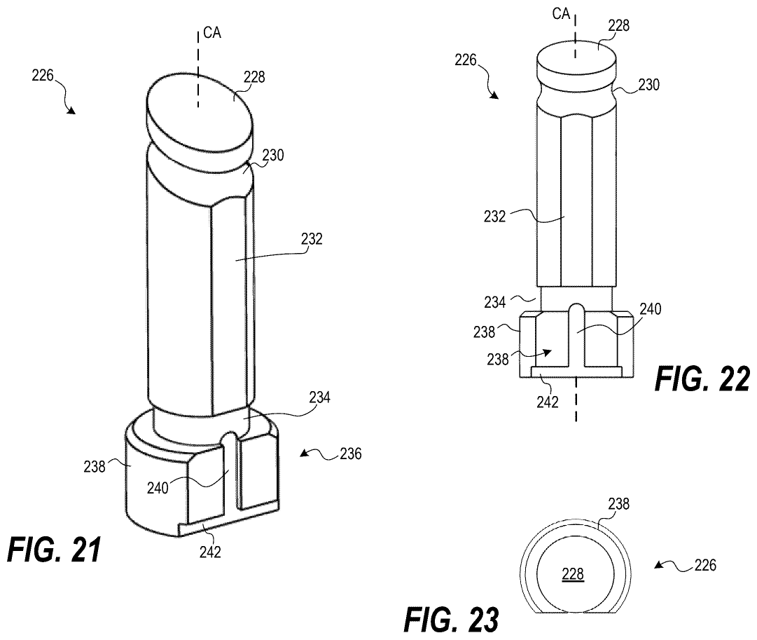

FIGS. 21-23 depict an embodiment of a flow-through pin 226. In some of the disclosed embodiments, the flow-through pin 226 is the same as the flow-through pins 128, 162. For example, the flow-through pin 226 may be used in conjunction with the mold assembly 100 to provide direct venting through the vacuum bushing 154. The flow-through pin 226 extends longitudinally generally parallel to a center axis CA. The flow-through pin 226 further includes a vent portion extending along a length of the flow-through pin 226. The vent portion enables air to travel along the longitudinal length of the flow-through pin 226 while the flow-through pin 226 is positioned in one of the surrounding through holes 146 of the mold cavity 136.

The flow-through pin 226 may be similar to the center vent pin 200 to enable direct venting. The flow-through pin 226 includes an upper surface 228. In an embodiment, the upper surface 228 is an inverted dimple shape and configuration. The upper surface 228 is configured to fit within and at least partially fill the opening into a corresponding one of the surrounding through holes 146 to complete a missing area of the inner surface 140. The upper surface 228 may be curved and angled to match the inner surface 140 while maintaining a center axis that is parallel to the center axis of the center vent pin 200 when both are positioned in the mold cavity 136. In an exemplary embodiment, the upper surface 228 is part of an inverted dimple and fret pattern on the inner surface 140. While the depicted embodiment includes a whole dimple, it should be understood that the upper surface at the upper surface 228 can have other shapes and configurations, such as a shape including part of a fret and/or part of a dimple in an inverted dimple and fret pattern.

The flow-through pin 226 further includes a vent portion extending along a length thereof. The vent portion may include, for example, one or more of a proximal vent 230, a surface vent 232, a distal vent 234, and an exit vent 236. The proximal vent 230 and distal vent 234 may be formed as annular recesses. The surface vent 232 may be a flat portion of the flow-through pin 226 that provides a space for air to escape along a length of the flow-through pin 226. The flow-through pin 226 may include a support block 238. The support block 238 includes a maximum diameter. In an exemplary embodiment, the exit vent 236 is formed as a recess from the maximum diameter in the support block 238. In some embodiments, the exit vent 236 may be a flat surface vent. In some embodiments, the exit vent 236 may include a longitudinal channel 240 and a transverse channel 242 at a distal end of the flow-through pin 226. The vent portion of the flow-through pin 226 provides direct venting that enables air to quickly and efficiently travel in a direction parallel to the y-axis through the surrounding through holes 146 and exit through the exit vent 236 toward the vacuum bushing 154 during molding.

A disclosed mold assembly includes a mold and a corresponding interior spherical cavity for receiving a golf ball subassembly and molding at least one layer around the golf ball subassembly in a molding process. During the molding process, the interior spherical cavity is configured to be vented of air to enable the space to be filled with the material forming the at least one layer. The mold assembly includes the mold cavity 136, the vacuum bushing 154, a plurality of the retractable pins 164, the stationary center vent pin 200, and a plurality of the stationary flow-through pins 226. The mold assembly may include opposing sets of these components. The center vent pin 200 and the flow-through pins 226 are configured to be positioned in the mold cavity 136 and include a vent portion enabling the interior spherical cavity to be vented through the mold cavity 136 along the center vent pin 200 and the flow-through pins 226 in a direction parallel to the y-axis. Air/gas produced in the interior spherical cavity during molding is drawn from the interior spherical cavity, through the mold body 138, through the vacuum bushing 154 and into the collection area 170 when sufficient suction/vacuum is provided thereto from outside the mold. Of course, embodiments are envisioned wherein the suction/vacuum is provided inside the mold assembly, especially at a distal end of the mold assembly which in some embodiments would be located at distal ends of retractable pins within the mold assembly.

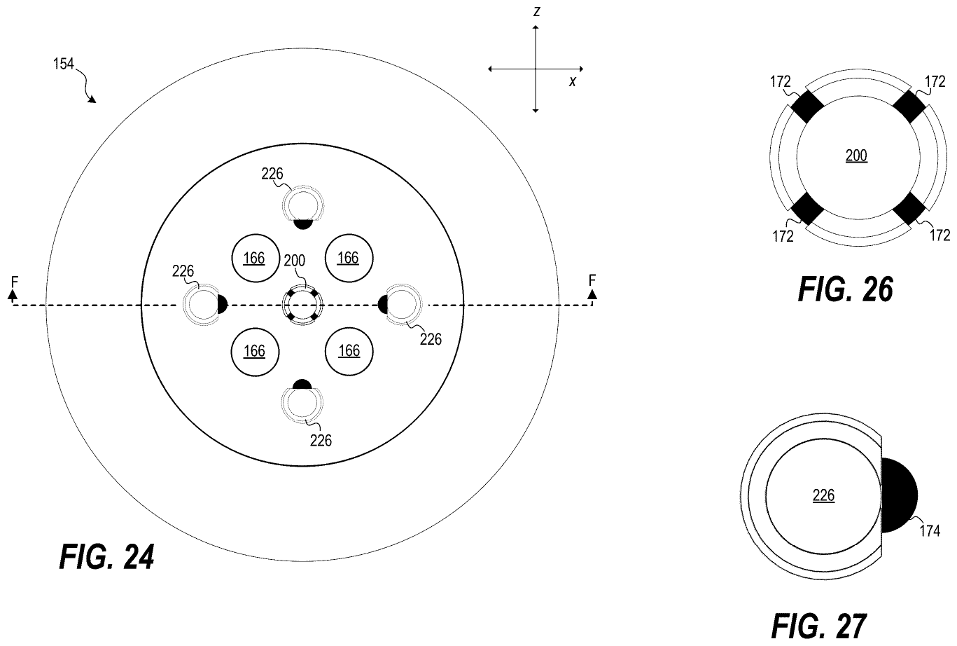

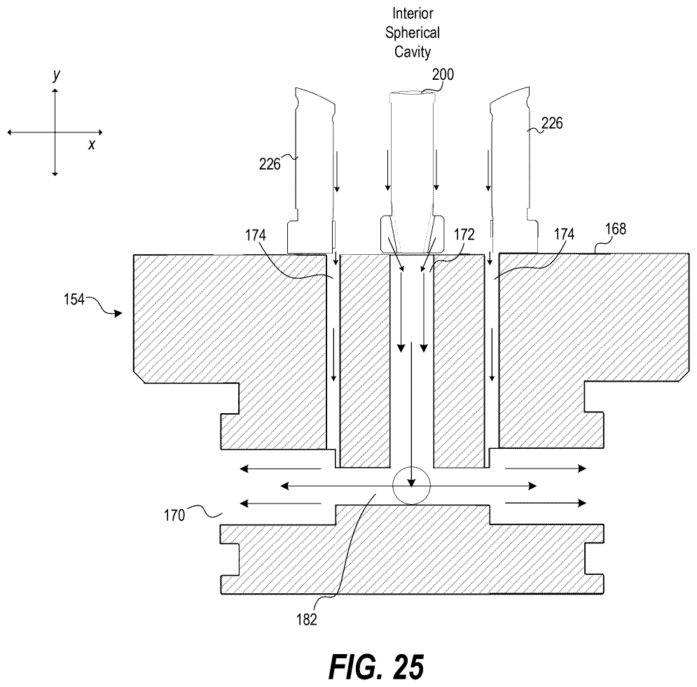

FIG. 24 is a top view of a portion of an exemplary mold assembly. FIG. 25 is a cross-sectional view taken through line F-F of FIG. 24. The depicted portion of the mold assembly includes the vacuum bushing 154, center vent pin 200, and four flow-through pins 226. The cross-sectional view of FIG. 25 is taken through the center vent hole 172 and two surrounding vent holes 174 of the vacuum bushing 154. As shown, the center vent pin 200 is aligned with the center vent hole 172 and partially covers the opening into the center vent hole 172. Each flow-through pin 226 is aligned with and partially covers the opening into a respective one of the surrounding vent holes 174.

FIG. 26 is a close-up of the top view of the center vent pin 200 partially covering the opening into the center vent hole 172. As a result, the opening includes a covered portion that is covered by the center vent pin 200 and an uncovered portion (shown in black) that is not covered by the center vent pin 200. In an exemplary embodiment, the covered portion is blocked by the center vent pin 200 being stationary and resting above the cavity-side surface 168 of the vacuum bushing. In some embodiments, the support block 214 has a maximum diameter that is greater than the diameter of the opening into the center vent hole 172, thereby enabling the center vent pin 200 to be aligned with the center of the opening into the center vent hole and be supported at its maximum diameter perimeter. As a result, the covered portion of the opening of the center vent hole 172 includes the center point of the opening. According to at least some embodiments, the center point is a geometric center of the shape of the opening. For example, for a circular opening, the center point is the center of the circle. In an exemplary embodiment, the uncovered portion of the opening into the center vent hole 172 is formed by the exit vent(s) 216 at an area at the perimeter of the opening into the center vent hole 172. In the depicted embodiment, the four exit vents 216 create an uncovered portion that includes a plurality of separate areas spaced around the perimeter of the opening into the center vent hole 172. Each area of the uncovered portion provides space for air to directly vent from the mold cavity 136 through the center vent hole 172.

FIG. 27 is a close-up of the top view of one of the flow-through pins 226 partially covering the opening into one of the surrounding vent holes 174. Similar to the center vent pin 200, the opening into the surrounding vent hole 174 includes a covered portion that is covered by the flow-through pin 226 and an uncovered portion (shown in black) that is not covered by the flow-through pin 226. In an exemplary embodiment, the flow-through pin 226 is positioned such that the center of the flow-through pin 226 is not aligned with the center of the opening into the surrounding vent hole 174. In some embodiments, the exit vent 236 of the flow-through pin 226 is positioned near the center of the opening into the surrounding vent hole 174. As a result, the covered portion of the opening is approximately half of the opening and the uncovered portion of the opening is approximately the other half of the opening, as shown in FIG. 27.

FIG. 25 further depicts a plurality of vent paths that are formed to connect the interior spherical cavity to the collection area 170 of the vacuum bushing 154. The vent paths provide direct venting through the mold cavity 136 and the vacuum bushing 154. The vent paths include at least one center vent path along the vent portion(s) of the center vent pin 200 (which is through the center through hole 144 of the mold cavity 136) and then through the center vent hole 172 leading to the collection area 170. The vent paths also include at least one surrounding vent path along the vent portion(s) of each flow-through pin (which is through a surrounding through hole 146 of the mold cavity 136) and then through a corresponding surrounding vent hole 174 also leading to the collection area 170.

In some aspects, the vent paths include a mold cavity portion in which air runs along a vent portion of the plurality of pins, including the center vent pin 200 and the flow-through pins 226. The vent paths further include a bushing portion in which the air continues past the plurality of pins and into the openings into the center vent hole 172 and surrounding vent holes 174 via the uncovered portions of those openings. In the center vent path(s) the air travels through the center vent hole 172 to the exit junction 186 before traveling through one of the exit channels 182 and out into the collection area 170. In the surrounding vent path(s), the air travels through the surrounding vent holes 174 to the collection area 170.

The disclosed embodiments include multiple generally parallel vent paths that enable direct venting through a stationary center vent pin and stationary flow-through pins. In some embodiments, additional venting may occur via the retractable pins. U.S. Pat. No. 11,529,755, which is incorporated herein by reference in its entirety, discloses a mold assembly having retractable pins and further discloses venting via the retractable pins. In some embodiments, the retractable pins and related features may be the same as or similar to the retractable pins described in U.S. Pat. No. 11,529,755.

The disclosed mold assembly with a venting assembly produces multiple venting paths that enables the molding of thin golf ball layers quickly and efficiently. The disclosed embodiments may be particularly applicable to molding thin cover layers for golf balls. Materials for cover layers and other golf ball components may be consistent with other materials used in RPIM methods. Examples of materials used for golf balls that may also be used in conjunction with the present disclosure are also described in U.S. Pat. No. 11,529,755.

When numerical lower limits and numerical upper limits are set forth herein, it is contemplated that any combination of these values may be used. Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention.

It is understood that the manufacturing methods, mold apparatus, compositions, constructions, and products described and illustrated herein represent only some embodiments of the invention. It is appreciated by those skilled in the art that various changes and additions can be made to methods, mold apparatus, compositions, constructions, and products without departing from the spirit and scope of this invention. It is intended that all such embodiments be covered by the appended claims.

1. A golf ball mold assembly, comprising:
a mold comprising a mold body and an arcuate inner surface comprising an inverted dimple and fret pattern, the mold defining an interior spherical cavity for holding a golf ball subassembly, the mold comprising a plurality of through holes including a center through hole and a plurality of surrounding through holes;
a venting assembly comprising:
a plurality of pins extending parallel to an axis, the plurality of pins comprising a stationary center vent pin positioned in the center through hole, a plurality of stationary flow-through pins, and a plurality of retractable pins, wherein the center vent pin and the plurality of stationary flow-through pins each comprise a vent portion extending along a length thereof, wherein the plurality of stationary flow-through pins and the plurality of retractable pins are positioned in the plurality of surrounding through holes; and
a vacuum bushing comprising a cavity-side surface, a collection area, and a plurality of vent holes each having an opening in the cavity-side surface and leading to the collection area through the vacuum bushing, wherein the plurality of vent holes extend parallel to the axis and comprise a center vent hole and a plurality of surrounding vent holes,
wherein a plurality of vent paths are formed from the interior spherical cavity to the collection area of the vacuum bushing, including at least one center vent path through the center through hole and the center vent hole and at least one surrounding vent path through a surrounding through hole and a surrounding vent hole.

2. The golf ball mold assembly of claim 1, wherein the plurality of through holes are parallel to the axis and extend from the interior spherical cavity through the mold body to a distal surface of the mold body.

3. The golf ball mold assembly of claim 2, wherein the distal surface of the mold body is positioned adjacent to the cavity-side surface of the vacuum bushing.

4. The golf ball mold assembly of claim 1, wherein the center vent pin partially covers the opening of the center vent hole and the plurality of stationary flow-through pins partially cover the openings of respective surrounding vent holes.

5. The golf ball mold assembly of claim 1, wherein the vacuum bushing comprises a plurality of retractable pin through holes extending from the cavity-side surface to a distal end of the vacuum bushing, wherein the plurality of retractable pins are positioned in the plurality of retractable pin through holes in the vacuum bushing.

6. The golf ball mold assembly of claim 5, wherein the collection area is between the cavity-side surface and the distal end of the vacuum bushing along a direction parallel to the axis.

7. The golf ball mold assembly of claim 5, wherein the vacuum bushing comprises four surrounding vent holes and four retractable pin through holes.

8. The golf ball mold assembly of claim 1, wherein the collection area comprises an annular recess.

9. The golf ball mold assembly of claim 1, wherein the vacuum bushing comprises an exit channel connecting the center vent hole to the collection area.

10. The golf ball mold assembly of claim 9, wherein the exit channel extends in a direction perpendicular to the axis.

11. The golf ball mold assembly of claim 10, wherein the vacuum bushing comprises a plurality of exit channels connecting the center vent hole to the collection area.

12. The golf ball mold assembly of claim 11, wherein the surrounding vent holes connect to a portion of a respective exit channel.

13. A vacuum bushing for a golf ball mold assembly, comprising:
a cavity-side surface, a distal end, and a collection area between the cavity-side surface and the distal end in a direction parallel to an axis;
a plurality of retractable pin through holes extending from the cavity-side surface to the distal end;
a plurality of vent holes each having an opening in the cavity-side surface and leading to the collection area, the plurality of vent holes extending parallel to the axis and comprising a center vent hole and a plurality of surrounding vent holes; and
an exit channel connecting the center vent hole to the collection area.

14. The vacuum bushing of claim 13, wherein the exit channel extends in a direction perpendicular to the axis.

15. The vacuum bushing of claim 14, wherein the vacuum bushing comprises a plurality of exit channels connecting the center vent hole to the collection area.

16. The vacuum bushing of claim 15, wherein the surrounding vent holes connect to a portion of a respective exit channel.

17. The vacuum bushing of claim 16, wherein the openings into the surrounding vent holes have a smaller diameter than the opening into the center vent hole.

18. A golf ball mold assembly, comprising:
a mold comprising a mold body and an arcuate inner surface comprising an inverted dimple and fret pattern, the mold defining an interior spherical cavity for holding a golf ball subassembly, the mold comprising a plurality of through holes including a center through hole and a plurality of surrounding through holes; and
a venting assembly, comprising:
a plurality of pins extending parallel to an axis, the plurality of pins comprising a stationary center vent pin positioned in the center through hole and a plurality of retractable pins positioned in the plurality of surrounding through holes, wherein the center vent pin comprises a vent portion extending along a length thereof; and
a vacuum bushing comprising a cavity-side surface, a collection area, and a center vent hole having an opening in the cavity-side surface and leading to the collection area, wherein the center vent hole extends parallel to the axis,
wherein the opening of the center vent hole includes a covered portion that is covered by the center vent pin and an uncovered portion that is not covered by the center vent pin, wherein the uncovered portion forms part of a vent path from the interior spherical cavity to the collection area of the vacuum bushing, and wherein the covered portion of the opening of the center vent hole includes the center point of the opening.

19. The golf ball mold assembly of claim 18, wherein the uncovered portion of the opening of the center vent hole includes an area at a perimeter of the opening of the center vent hole.

20. The golf ball mold assembly of claim 19, wherein the area at the perimeter of the opening of the center vent hole includes a plurality of separate areas spaced around the perimeter of opening of the center vent hole.

21. The golf ball mold assembly of claim 18, wherein the vent portion comprises at least one annular recess, at least one surface vent, and at least one exit vent.

22. The golf ball mold assembly of claim 21, wherein the center vent pin comprises along the axis a proximal section, a middle section, and a distal section, wherein the proximal section comprises the annular recess, the middle section comprises the at least one surface vent, and the distal section comprises a support block and the at least one exit vent formed in the support block.

23. The golf ball mold assembly of claim 22, wherein the support block is an enlarged end of the center vent pin relative to the proximal and middle sections of the center vent pin, the support block having a maximum diameter through the center axis of the center vent pin.

24. The golf ball mold assembly of claim 23, wherein the maximum diameter of the support block is greater than the diameter of the opening of the center vent hole.

25. The golf ball mold assembly of claim 24, wherein each exit vent is formed as a recess from the maximum diameter toward the center axis of the center vent pin.

26. The golf ball mold assembly of claim 25, wherein the support block comprises a first end adjacent to the middle section of the center vent pin, and an opposite second end,
wherein each recess extends from the first end to the second end to form a complete path through the support block.

27. The golf ball mold assembly of claim 26, wherein each exit vent comprises an exit surface within the recess, the exit surface extending from the first end to the second end.

28. The golf ball mold assembly of claim 27, wherein the exit surface is pitched toward the center axis of the center vent pin such that the recess has width increasing from the first end to the second end.
